(19) United States
(12) Patent Application Publication
(10) Pub. No.: US 2014/0082555 A1
(43) Pub. Date: Mar. 20, 2014

(54) DEVICE AND METHOD FOR USING A TRACKBALL TO SELECT ITEMS FROM A DISPLAY

(71) Applicants: Jonathan WALLACE, Coral Springs, FL (US); Joseph SAIB, Santa Clara, CA (US)

(72) Inventors: Jonathan WALLACE, Coral Springs, FL (US); Joseph SAIB, Santa Clara, CA (US)

(73) Assignee: APPSENSE LIMITED, Warrington (GB)

(21) Appl. No.: 13/619,596

(22) Filed: Sep. 14, 2012

(51) Int. Cl. G06F 3/048

(52) U.S. Cl. 715/830

(57) ABSTRACT

Embodiments of the invention include a selection device for use with a user computer and method for using the device. The selection device performs a process of providing a user with a plurality of menu icons for a plurality of computer applications on the selection device and a process of allowing a user to select a menu icon corresponding to a particular application for viewing on the user computer display. To do this, the device and method may implement the steps of displaying the plurality of menu icons representing applications available to the user on the user computer on the selection device display; enabling the user to scroll through the plurality of menu icons to select the menu icon corresponding to the particular application, and responsive to the user selecting the menu icon, transmitting an identifier for the particular application to the user computer.

### FIELD OF THE INVENTION

The following invention relates generally to selection devices for a computer and more particularly to selection devices for a computer that integrate a display for displaying user program options and a trackball to receive a program selection from a user.

### BACKGROUND OF THE INVENTION

Currently, when a user connects to a computer application, the user uses a keyboard or mouse controller to select and open any application the user would like to run. For example, to open a word processing application the user must navigate a pointer to a menu with the application, click the menu to open same, then navigate to the word processing application and click on the application. Accordingly, for many applications, the process to open the application can involve multiple clicks and mouse movements, and can delay the user from accessing the application. To reduce the number of steps to open an application, many operating systems incorporate a desktop or ribbon that allows the user to copy applications from the main menu onto same. As one skilled in the art will appreciate, a ribbon is a graphical user interface where a set of toolbars for an application are placed on tabs in a tab bar. Copying such applications to the ribbon or desktop may eliminate the steps of navigating to the main menu and clicking the main menu, but the user still must navigate to the application on the desktop or ribbon and click the application to access same. Moreover, if too many applications appear on the desktop or ribbon, the user may have difficulty finding the application they wish to open, further delaying application access. For example, a user may have several dozen icons representing applications, documents, photos and other files appearing on the desktop. In some instances, these materials may be organized by last access date, alphabetically, or in another faction provided that the user invests time to organize same. It is more likely, however, that the applications will not be readily accessible to the user because the applications will be disorganized and the user will have to search for the appropriate application. Finally, to open an application on the desktop, the user must minimize any open application on his/her computer screen to search for the application. For example, if the user is typing in a word processing application and would like to listen to music from his/her desktop, the user would have to minimize the application by navigating to and selecting the minimize tab. Then, the user must find the application for his music, and the volume of the speakers, which all require navigation through several windows and selection processes.

Moreover, as one skilled in the art will appreciate, though a mouse using a trackball is well-known, such a mouse must be used in the manner discussed above to navigate between applications. For example, U.S. Pat. No. 5,854,621 to Junod et al, U.S. Pat. No. 4,581,609 to Hosogoe et al., U.S. Pat. No. 4,952,919 to Nippoldt, and U.S. Pat. No. 5,122,654 to Koh et al. each teach wired or wireless mice and trackball assemblies used in conjunction with a user computer as an input device, but each assembly requires the user to move the trackball and actuate buttons on the mouse to navigate between computer applications. Accordingly, none of these prior art devices reduce the number of steps that are required for a user to open a computer application.

A need exists for a method and device that solves the issues identified above.

### SUMMARY OF THE INVENTION

Some embodiments of the invention include a selection device for selecting an application to view on a user computer display associated with a user computer. The selection device may comprise a trackball input device, a selection device display and a tangible, non-transitory memory. The memory may have stored thereon computer instructions for performing a process of providing a user with a plurality of menu icons for a plurality of computer applications and a process of allowing a user to select a menu icon corresponding to a particular application for viewing on the user computer display, and the instructions may include displaying the plurality of menu icons representing the plurality of applications available to the user on the user computer on the selection device display; enabling the user to scroll through the plurality of menu icons to select the menu icon corresponding to the particular application to view on the user computer display; and responsive to the user selecting the menu icon, transmitting an identifier for the particular application to the user computer.

Other embodiments of the invention may include a computer program product comprised of a series of instructions executable on a computer. The computer program product may perform a process of providing a user with a plurality of menu icons for a plurality of computer applications and a process of allowing a user to select a menu icon corresponding to a particular application for viewing on the user computer display, and the instructions implementing the program product may include displaying the plurality of menu icons re presenting the plurality of applications available to the user on the user computer on the selection device display; enabling the user to scroll through the plurality of menu icons to select the menu icon corresponding to the particular application to view on the user computer display; and responsive to the user selecting the menu icon, transmitting an identifier for the particular application to the user computer.

Embodiments of the invention include a computer-implemented method comprised of a series of instructions that cause a computer to perform a process of providing a user with a plurality of menu icons for a plurality of computer applications and a process of allowing a user to select a menu icon corresponding to a particular application for viewing on the user computer display. The computer-implemented method may implement the steps of displaying the plurality of menu icons representing the plurality of applications available to the user on the user computer on the selection device display; enabling the user to scroll through the plurality of menu icons to select the menu icon corresponding to the particular application to view on the user computer display; and responsive to the user selecting the menu icon, transmitting an identifier for the particular application to the user computer.

### BRIEF DESCRIPTION OF THE DRAWINGS

So that the features and advantages of the invention may be understood in more detail, a more particular description of the invention briefly summarized above may be had by reference to the appended drawings, which form a part of this specification. It is to be noted, however, that the drawings illustrate only various embodiments of the invention and are therefore not to be considered limiting of the invention's scope as it may include other effective embodiments as well.

FIG. 1 is a perspective view of a selection device having a trackball according to an embodiment of the invention;

FIG. 2 is an electronic block of a selection device having a trackball according to an embodiment of the invention;

FIG. 3 is a software block diagram of a selection device having a trackball according to an embodiment of the invention;

FIG. 4 is a software flow diagram for adding applications to a selection device having a trackball according to an embodiment of the invention;

FIG. 5 is a software flow diagram for selecting the application from a selection device having a trackball according to an embodiment of the invention;

FIG. 6 is an exemplary graphical user interface (“GUI”) on a user computer according to an embodiment of the invention; and

FIG. 7 is an exemplary graphical user interface (“GUI”) on the selection device according to an embodiment of the invention.

### DETAILED DESCRIPTION

To address the need set forth above, according to one aspect, embodiments of the invention include a user input device for operating a computer that has a trackball assembly and a display on or around the trackball assembly for presenting the user with application options on same. Such applications may be uploaded to a microcontroller or microprocessor operating the user input device from the computer, and therefore the user can interact with the computer without manipulating a cursor on the user computer display. In this way, embodiments of the invention simplify the initiation of a computer application or menus for a computer application.

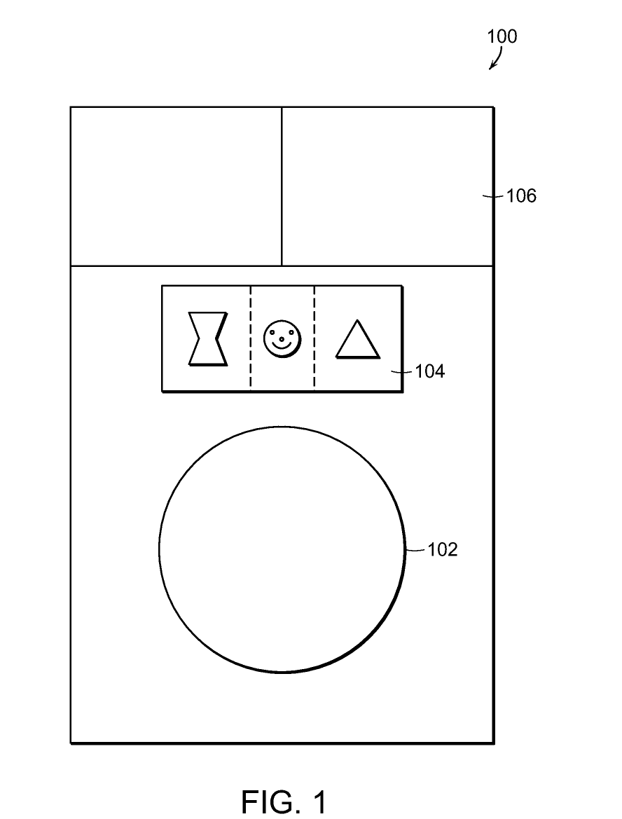

More specifically, as can be seen in FIG. 1, the selection device includes a trackball 102, a selection device display 104 and user selection buttons 106. As one skilled in the art will appreciate, the trackball 102 can be disposed on the upper surface of the selection device 100 to allow the user to position a cursor on the user's computer screen (not shown). The selection device display 104 is also disposed on the upper surface of the selection device 100 and is used to display application selections the user has downloaded to a selection device computer (not shown). In some embodiments, the selection device display and trackball are integrated (e.g., the selection device display is disposed on or with the trackball). In a preferred embodiment, the selection device display may be a touch screen that enables a user to scroll through and select one or more applications using touch. In some embodiment, user selection buttons 106 may also be included on the selection device to enable the user to select an application from the selection device display or the user computer display. For example, in some embodiments, the user may select an application from the display or user computer display by navigating the cursor over the selection and tapping the trackball 102 or using one or more user selection buttons 106. Alternatively, the user may navigate a selection window on the display or a cursor on a computer display over a user prompt using the trackball and hover over an item or tap the trackball to select the user prompt (e.g., for an application to open or close, for an application to expand or minimize, to print, save, or close a program, to download an application or data or to burn the application or data to a disk or USB, etc.). In other embodiments, the user may select user prompts using buttons 106. For example, the buttons may be used to select an application appearing in a selection window of the display or to navigate through computer display prompts for the application appearing in a selection window (e.g., the user may use the trackball to navigate applications into and from a selection window, use the buttons to select an application in a selection window and once the application is open, use successive taps of the buttons to open various menus for the application in the window). As one skilled in the art will appreciate, the trackball or one or more selection buttons 106 may be provided for the selection of display prompts as well as the application on the computer display as well (i.e., the trackball and selection buttons can be used to select items on a computer display or in a selection window of the selection device). In this regard, different selection buttons may be used for different application function, such as a right button to open a menu of most used commands for a particular program and a left button to make a user selection (e.g., to select the display prompt).

As one skilled in the art will appreciate, the arrangement of the user input device in FIG. 1 is exemplary, and other embodiments will be readily apparent. For example, the trackball device may be used with a tablet computer or SmartPhone, and as such, the user input device may only utilize a trackball, or utilize a trackball with one or more user input buttons arranged apart from, or in close proximity to, the trackball in any arrangement. Moreover, for such an arrangement, the device display, trackball, and any buttons may be integrated on user computer in the same housing (e.g., user computer would include any arrangement of the trackball, buttons and display in the computer housing). As one skilled in the art will appreciate, in application where the user computer and user input device described above are integrated into the same housing, the device display may appear on the trackball so the user computer would not include two display screens. In other embodiments, the user input device may be a separate component from the user computer, but exclude one or all buttons, or include more buttons than those shown. Moreover, though a trackball is disclosed herein, applications substituting a joystick, remote controller, or roller ball (under the user input device) may also incorporate the display screen described herein and should be considered part of this disclosure.

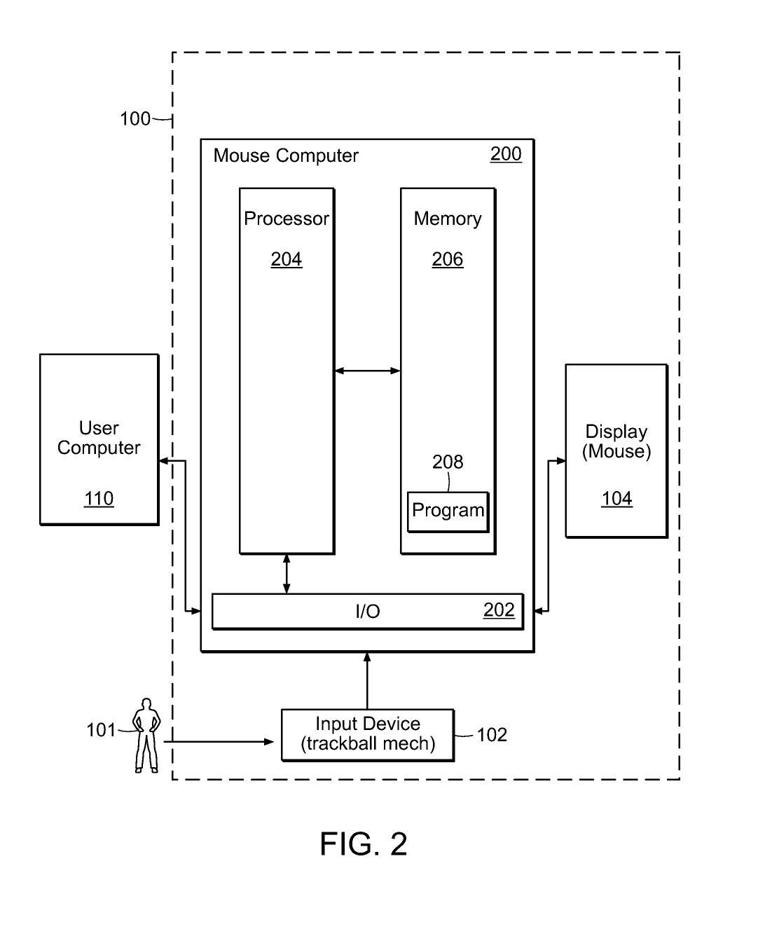

Turning to FIG. 2, the electronics of the selection device are described. As can be seen, the selection device includes computer 200, display 104 and input device 102, which interact with the user computer 110 and the user 101. The display 104 and input device 102 are discussed in detail above with reference to FIG. 1. The selection device computer 200 is connected to the display 104 on the selection device, the trackball, and/or the user computer display (not shown) associated with the user computer 110. As one skilled in the art will appreciate, user computer 110 can be any type of computing device (e.g., a desktop computer, laptop computer, personal digital assistant (PDA), cellular telephone such as a Smartphone (Blackberry®, iPhone®, Android®-based phone), computer tablet, networked computer terminal, television as well as any other electronic device capable of connecting to the selection device 100 to enable system interaction with user 101). Moreover, a computer display may not be integrated into user computer 110 in some embodiments (e.g., within the same housing, and are therefore housed in separate devices or components). As such, the display may be a display integrated in the same general housing with the user computer (e.g., a laptop or iPad® or similar device). In other embodiment, the display may be a wired or wireless monitor connected to the user computer 110 as an output device (e.g., a flat panel monitor connected to a desktop). As one skilled in the art will appreciate, in some embodiments, display may be a monitor connected to the user computer 110 via a network, while in other embodiments the display can be in close proximity to the selection device computer 200, e.g. a laptop, desktop, etc.

Selection device display 104 and trackball 102 may also comprise commercially available components. For example, display 104 may be a thin film transistor (TFT) LCD display, active matrix organic light-emitting diode (AMOLED) display, or other display that is capable of integrating onto the selection device such as those manufactured by LG Display, Varitronix, Samsung, AU Optronics, etc. Preferably, selection device display 104 allows for touch screen actuation (e.g., allows the user to scroll through a list of applications stored in the selection device and select same using touch instead of buttons). As one skilled in the art will appreciate, in embodiments where the selection device display is a touch screen, the user may select the application and any associated menus from the input device with or without the actuation of the associated trackball. The trackball 102 may be any optical or electro-mechanical trackball. For example, optical trackball devices and mechanisms are described in U.S. Pat. No. 4,794,384, which describes a method to use light to determine device position and in U.S. Pat. No. 6,781,570 describes a wireless selection device that uses a trackball and light to determine the trackball's position. In some embodiments, the trackball may integrate the selection device display therein, e.g., as a touch screen mechanism. In such embodiments, the user computer may be imbedded within the trackball as a touch screen or selection mechanism as described above and may output data to the user computer using a wired or wireless connection to same.

Selection device computer 200 can be one or more microcontrollers or microprocessors comprising a memory 206, a program product 208, a CPU 204, and an input/output device (“I/O device”) 202 (e.g., those manufactured by Intel, Freescale, Analog Devices, Texas Instruments, etc.). As one skilled in the art will appreciate, the selection device computer 200 may be separate from a microcontroller that senses optical movement of the trackball or the selection device computer 200 may integrate the functions of or include an optical mouse microcontroller. As such, the selection device computer 200 may receive input from the optical sensors for trackball movement, the selection device display and the user computer 110. Moreover, components that may be included as part of user computer 200 to implement wired or wireless trackball device, such as a phase locked loop, antenna, etc., though not shown, can be considered components of the selection device computer 200 and/or peripherals thereto. In any case, I/O device 202 connects the selection device computer 200 to the display 104, the trackball 102 (as a separate controller and/or optical or electro-mechanical trackball sensor) and the user computer 110, and can be any I/O device including, but not limited to a serial port, input/output pin, CAN bus, etc. as required by the implementation of the embodiments described herein.

As can be seen, the I/O device 202 is connected to the CPU 204. CPU 204 is the “brains” of the selection device computer 200, and as such executes program product 114 and works in conjunction with the I/O device 202 to direct data to memory 206 and to send data from memory 206 to the user computer 110 and the selection device display 104. CPU 204 can be any part of any commercially available microcontrollers or microprocessors (e.g., 32 bit processor, 64 bit processor, etc.). As one skilled in the art will appreciate, such processor may control both the application selection features and the optical and electro-mechanical detection of trackball or mouse movement.

Memory 206 may store the algorithms forming the computer instructions of the instant invention and data, and such memory 206 may consist of both non-volatile memory (ROM, flash memory, etc.) and volatile memory (RAM) as required by embodiments of the instant invention. As one skilled in the art will appreciate, though memory 206 is depicted in the selection device computer 200, memory 206 may also be a separate component or device (e.g., FLASH memory or other storage) connected to the selection device computer 200.

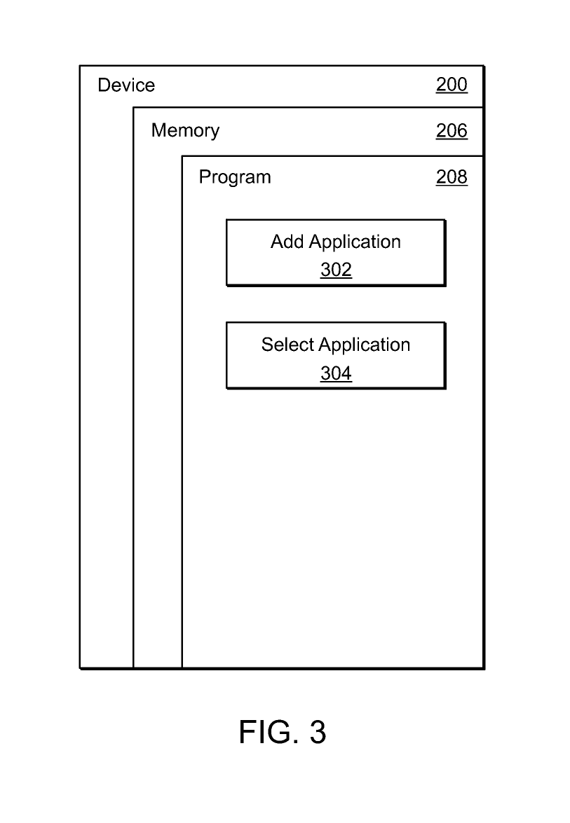

As shown in FIGS. 3-5, an embodiment for computer instructions implementing some of the functionality of the program product 208 of the instant invention is stored in memory 206 as a plurality of programming modules. Such modules may include an add application module 302 and a select application module 304.

The add application module 302 includes instruction to add applications to the selection device computer 200. For example, the add application module 302 may format a display screen for the user to drag applications into the display screen to enable a copy of an icon representing the application to be sent to the selection device computer 200. In other embodiments, the application module 302 may interact with a computer program on the user computer to enable the user to associate certain icons with particular applications on the user computer 110. For example, the selection device computer 200 may be pre-programmed with icons for games, a word processing program, a media player, etc., and the user can select the icons to associate with the particular applications. In some embodiments, the icons can be customized and stored on the selection device computer. For example, a user may wish to associate their child or a family member with a Photoshop program, and a money symbol with a banking program. In such instances, the add application module may transmit the new icons to the selection device computer 200 to store as a new icon for presentation to the user. As one skilled in the art will appreciate, applications may be associated with icons automatically after the enumeration process for the selection device (e.g., after the computer recognized the device, controller asks the user computer for and associates particular applications with a particular icon). For example, the selection device may be programmed to associate a word processing application with a word processing icon, and therefore searches the user computer for such a program to associate with this icon.

The select application module 304 may include instructions to select an application from the selection device display 104. In this regard, in some embodiments, the selection module may include instructions that enable the user to scroll and select an icon from the selection device display 104. Such instructions may also include instructions for formatting selection data for output to the user computer using the selection device computer I/O.

As one skilled in the art will recognize, the computer modules may use existing drivers for a USB device or a driver may be developed for the hardware device using operating system protocols to implement the functions of the add application module 302 and the select application module 304. For example, Microsoft provides standard drivers and device driver protocols that may form the basis for the communication of instructions implementing the modules, and as such, the selection device can be recognized by the user computer after a standard enumeration procedure. As one skilled in the art will also appreciate, the previous modules are exemplary only and other modules and/or combination of modules may be implemented to achieve the functionality of the instant invention.

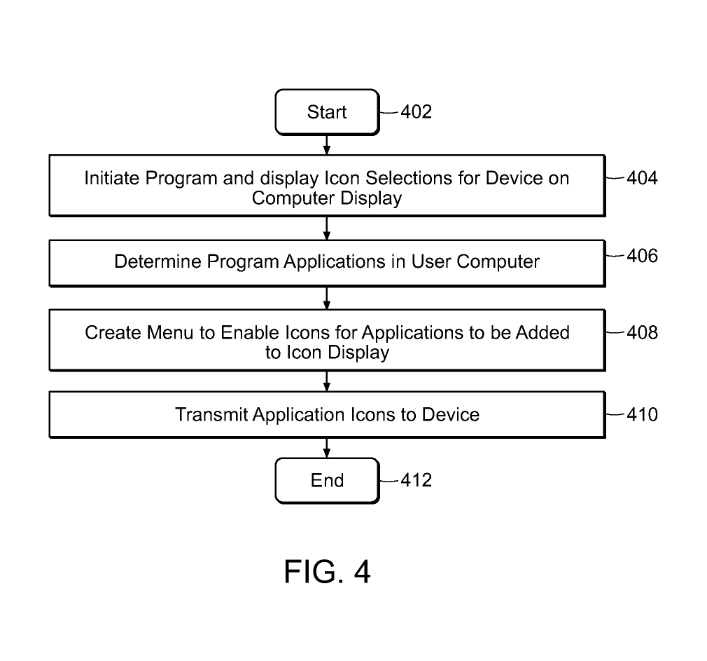

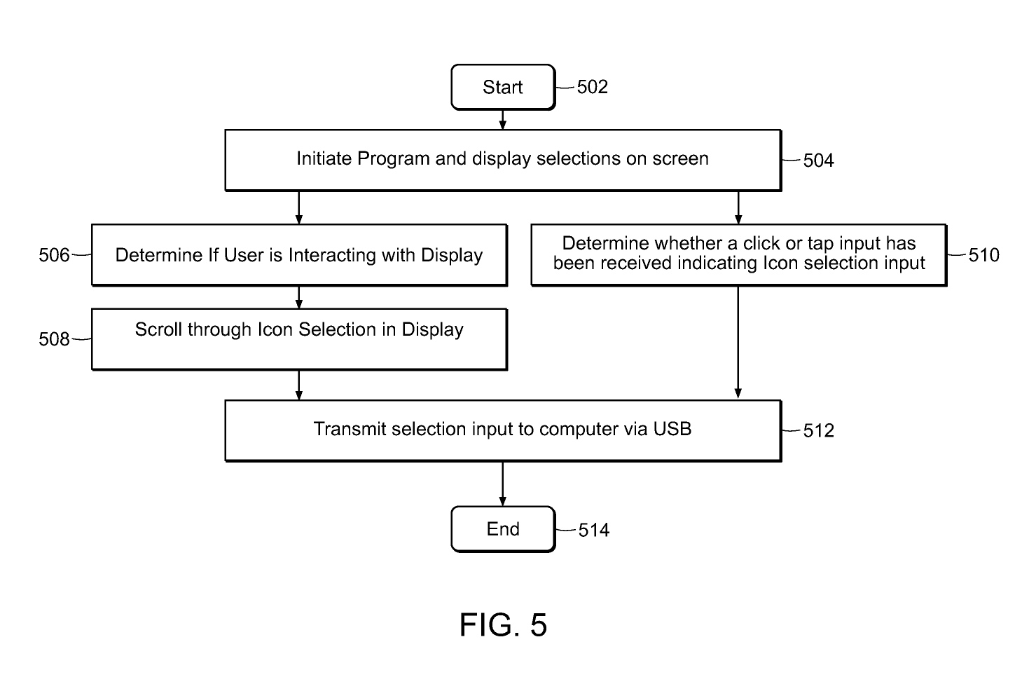

An exemplary embodiment of the computer program flow for processes implementing the add application module 302 and then the select application module 304 will now be discussed with reference to FIGS. 4 and 5, respectively. As one skilled in the art will appreciate, though the flow diagrams are shown as implemented in a serial configuration, such flow is for simplicity only and should be understood to include various loops and processes that may be run concurrently and/or used to implement each of the instructions, or a plurality of the instructions, therein.

Turning to FIG. 4, the add application module 302 is described and starts in step 402. In step 404, the instructions initiate the program and display program instruction on the computer display associated with the user computer. In some embodiments, the instructions may include formatting a graphical user interface (“GUI”) to enable the user to view display or icon selections to be loaded into the memory of the selection device computer 200. For example, the display may be formatted with icons that are pre-programmed into the selection device computer 200, and/or in other embodiments the instructions may include a display that enables to user to download the user's own icons to represent the applications (e.g., photos, clip art, etc.). Moreover, in some embodiments, the display selections presented to the user include applications in the user computer that are determined after the enumeration process for the selection device, and as such, the user can confirm or change such icons.

In step 406, the program determines the program applications in the user computer 110. For example, after the device enumeration process, the selection device may scan the user computer to determine the most used applications or those associated with pre-programmed icons. In other embodiments, the selection device may scan the user computer for the applications that appear in special user menus (e.g., those applications appearing on the user desktop or on the ribbon of the user's operating system interface). In step 408, the menu to associate applications with the device is initiated. In some embodiments, such menu allows the user to associate particular icons with application (e.g., by dragging a copy of the application into or over an icon that the user would like to represent the application). In some embodiments, the instructions may include the step of allowing a user to disassociate an icon with applications that were linked after device enumeration. Moreover, in some embodiments, the device may enable the user to disassociate some icons with user applications and associate new icons with new user applications (e.g., to remove some links to applications in the selection device and add other applications to the selection device). In step 410, the selection device receives the added application icons or associated icon selection data and formats same for presentation on the display. In some embodiments, an address for a memory location for an instruction calling the application is sent to the selection device computer 200, which can then be sent to the user computer when the user selects an application on the selection device. In step 412, the process ends. Moreover, as one skilled in the art will appreciate, though all embodiments for associating an application with an icon and downloading the icons to the selection device are not disclosed herein, all are included within the scope of this disclosure.

Turning to FIG. 5, the select application module is described and the instructions for initiating an application for the selection device is initiated in step 502. In step 504, the device and selection device display is initiated (e.g., when the user computer is turned on the selection device and application display is initiated). In some embodiments, the selection device is powered on by drawing current from the user computer and the initiation of the selection device computer initiates a display of the icons associated with the user applications in the selection device display. In some embodiments, the selection device includes a battery, and the display of the icons on the display is initiated upon the receipt of a signal from the user computer. As one skilled in the art will appreciate, the display function may also include instructions to display the icons associated with application on the user computer when the selection device computer “wakes” from a sleep state (e.g., after the display periodically goes blank or dark periodically to conserve energy, the display is shown upon the movement of the trackball or the depression of the buttons). Moreover, the selection device display may be initiated by a series of key or trackball taps in some embodiments (e.g., the user depresses a right key to initiate the display of icons). In this way, the selection device computer may prevent trackball inputs for user computer input from being confused with display input. In step 506, the selection device determines an icon to position under a visible or invisible cursor or selection window and whether the user is attempting to scroll one or more icon selections into the window. For example, the instructions may determine whether the user is touching or “flicking” the selection device display to move between icons in the list of icons associated with applications in the user computer or whether the user is moving the trackball to scroll between icons. Also, in some embodiments, the movement of the user's finger over the touch screen or on the trackball may scroll between display windows, with each window having a plurality of icons disposed thereon. In this way, the user may indicate a scroll input by navigating through display windows or a list of icons. And, in some embodiments, the initiation of the display initiates a corresponding display of the icons on the user computer display. For example, when the display of the menu on the selection device is initiated, the selection device may transmit signals to replicate the display on the user computer display (e.g., as a wheel, menu, or orb of selections).

In step 508, the selection device scrolls through the icons in response to the user movement in step 506. For example, the icons may pass through the selection window of the display in succession as a list or rotating orb, or a plurality of icons may be presented to the user in successive display windows (e.g., the windows of icons are scrolled through as opposed to the list of icons). Moreover, in embodiments where the display is a touch screen, the selection window may simply enlarge the icon available in the selection list or the user may tap any icon appearing in the selection device display without the use of the selection window. Accordingly, the selection device display may be adapted to present one or more icons to the user. In step 510, which may be executed after step 504 and/or step 508, the instructions determine the cursor position and/or whether a click or tap input has been received indicating a selection input. In this regard, in some embodiments, the user may select an application by tapping the display where the icon is positioned, tapping the trackball when a cursor or selection window is positioned over the icon the user wishes to select, or depressing one of the buttons. In other applications, the user input computer may open an application if the application's icon has been in a selection window of the selection device display a predetermined amount of time. Once the user has selected and icon, the selection input is transmitted to the user computer (e.g., via the serial port) in step 512. In step 514, the process ends.

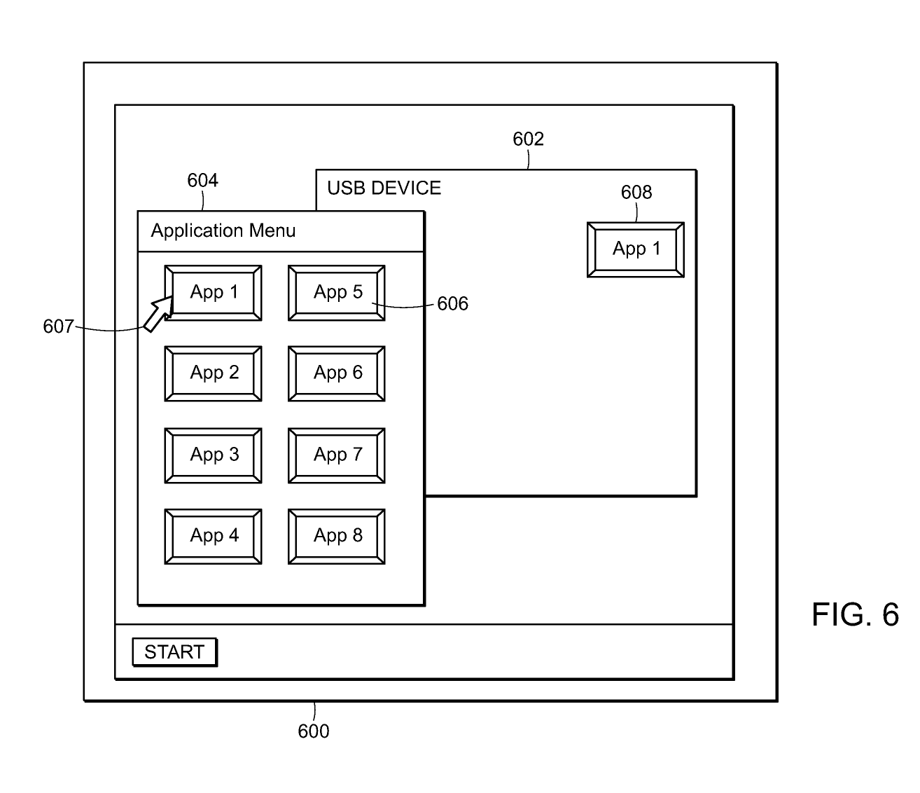

Turning to FIG. 6, a GUI implementing the menu having a plurality of applications listed thereon is described. As can be seen, the GUI is displayed on a user computer display 600, and includes a USB device window 602 listing application icons 608 and associated addresses for the icons in the selection device. An application menu 604 lists a plurality of applications 606 that may be associated with an icon that can be downloaded to the selection device. In some embodiments, the USB device window 602 is displayed to the user after the device's enumeration, and may be re-initiated when the user resets the selection device or request changes from an initial input screen (not shown). As one skilled in the art will appreciate, the application menu display may be a list of applications present on the user computer desktop, an application ribbon, or a menu of applications. In some embodiments, if a user would like to associate an application with the selection device, the user selects the application using cursor 607, and drags the application to the USB device window 602. In other embodiments, the user may click one of the mouse keys to copy the application icon and paste same in the USB device window. As one skilled in the art will appreciate, the icon for the application presented to the user upon initiating user computer Once the user has dragged or otherwise selected an application to place in the USB device window, the application is dragged to the USB device window 602.

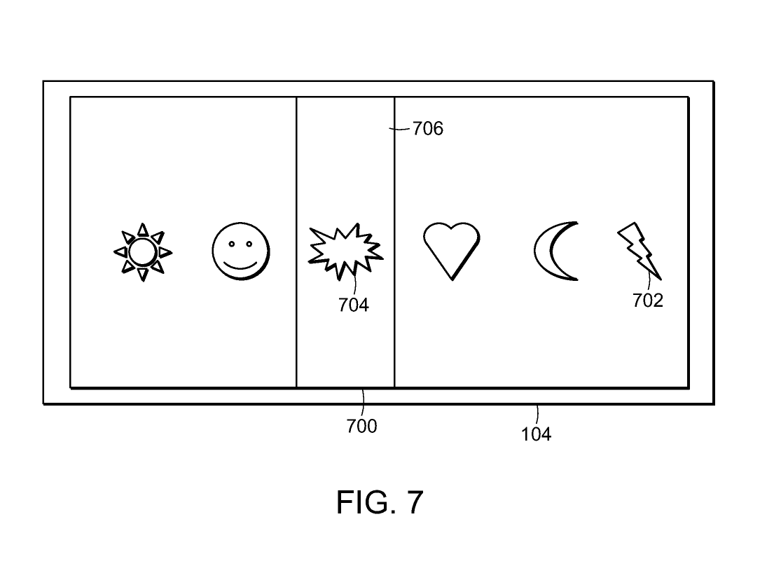

Turning to FIG. 7, an exemplary GUI for the selection window displayed in the user's input device in display 104. As can be seen, the user display includes a plurality of icons 702, and a selection window 700. As one skilled in the art will appreciate, icons 702 may also include words, photos of other applications indicating an invention. The display window 706 is provided to position the cursor over an icon 704 the user wishes to select. In this regard, the selected applications may be highlighted or enlarged if the selected application is within the window. As one skilled in the art will understand, however, in some embodiments, the user may select any icon or other indicator appearing in the selection device display.

As one skilled in the art will further appreciate, the display pages of FIGS. 6 and 7 are exemplary of the GUIs that may be initiated by the computer program of the instant invention to perform the inventive functions herein. Other GUIs may be created that will enable a user to select special icons for the applications to be loaded onto the selection device, add custom icons to the selection device, select to cancel an application from the menu (e.g., to remove an application from the menu of application icons on the selection device), select a rank for an application (e.g. to order the list of applications appearing in the selection device display), and set an interrupt tab (e.g., to enable an application or disable an application interrupt for a computer session). Accordingly, not all embodiments of such GUIs have been described herein, but will be apparent to one of skill in the art. Accordingly, various GUIs may be used instead of or in addition to the GUIs described herein, and the GUIs are in no way to be considered limiting to the specification and claims, but are used for a descriptive sense only.

Moreover, in the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification, and such modifications and changes are to be considered equivalents and part of this disclosure.

What is claimed is:

1. A selection device for selecting an application to view on a user computer display associated with a user computer, the selection device comprising:
a trackball input device, a selection device display and a tangible, non-transitory memory, the memory having stored thereon computer instructions for performing a process of providing a user with a plurality of menu icons for a plurality of computer applications and a process of allowing a user to select a menu icon corresponding to a particular application for viewing on the user computer display, the instructions including:
displaying the plurality of menu icons representing the plurality of applications available to the user on the user computer on the selection device display;
enabling the user to scroll through the plurality of menu icons to select the menu icon corresponding to the particular application to view on the user computer display; and
responsive to the user selecting the menu icon, transmitting an identifier for the particular application to the user computer.

2. The system of claim 1, wherein the instructions further include the step of:
determining whether the menu icon of the plurality of menu icons is in a selection window within the selection device display; and
highlighting the menu icon if it is in the selection window,
wherein the user can only select the menu icon when it is highlighted.

3. The system of claim 1, wherein the instructions further include the steps of:
determining whether the menu icon of the plurality of menu icons is in a selection window within the selection device display;
enlarging the menu icon if it is in the selection window so that it is larger than the plurality of icons,
wherein the user can only select the menu icon when it is enlarged.

4. The system of claim 1, wherein the instructions further include the step of:
determining whether the menu icon of the plurality of menu icons is in a selection window within the selection device display;
highlighting the menu icon if it is in the selection window; and
enlarging the menu icon if it is in the selection window,
wherein the user can only select the menu icon when it is highlighted and enlarged.

5. The system of claim 1, wherein the instructions further include the steps of:
uploading the plurality of icons corresponding to the plurality of applications from the user computer;
creating a menu using the plurality of icons corresponding to the plurality of applications from the user computer into a menu;
displaying the menu on the selection device display.

6. The system of claim 5, wherein the instructions further include the steps of:
responsive to the creation of the menu using the plurality of icons, transmitting the menu to the user computer for display on the user computer display; and
responsive to user scrolling through the menu, transmitting a cursor position to the user computer so that the menu on the user display replicates the menu on the selection device display.

7. The system of claim 5, wherein the instructions further include the step of:
allowing the user to determine the format for the menu from a group selected from a wheel, a page view, or an orb; and
enabling the user to determine an icon shape for the plurality of icons.

8. A computer program product comprised of a series of instructions executable on a computer, the computer program performing a process of providing a user with a plurality of menu icons for a plurality of computer applications and a process of allowing a user to select a menu icon corresponding to a particular application for viewing on the user computer display, the computer program product implementing the steps of:
displaying the plurality of menu icons representing the plurality of applications available to the user on the user computer on the selection device display;
enabling the user to scroll through the plurality of menu icons to select the menu icon corresponding to the particular application to view on the user computer display; and
responsive to the user selecting the menu icon, transmitting an identifier for the particular application to the user computer.

9. The computer program product of claim 8, wherein the instructions further include the step of:
determining whether the menu icon of the plurality of menu icons is in a selection window within the selection device display; and
highlighting the menu icon if it is in the selection window,
wherein the user can only select the menu icon when it is highlighted.

10. The computer program product of claim 8, wherein the instructions further include the steps of:
determining whether the menu icon of the plurality of menu icons is in a selection window within the selection device display;
enlarging the menu icon if it is in the selection window so that it is larger than the plurality of icons,
wherein the user can only select the menu icon when it is enlarged.

11. The computer program product of claim 8, wherein the instructions further include the step of:
determining whether the menu icon of the plurality of menu icons is in a selection window within the selection device display;
highlighting the menu icon if it is in the selection window; and
enlarging the menu icon if it is in the selection window,
wherein the user can only select the menu icon when it is highlighted and enlarged.

12. The computer program product of claim 8, wherein the instructions further include the steps of:
uploading the plurality of icons corresponding to the plurality of applications from the user computer;
creating a menu using the plurality of icons corresponding to the plurality of applications from the user computer into a menu;
displaying the menu on the selection device display.

13. The computer program product of claim 12, wherein the instructions further include the steps of:
responsive to the creation of the menu using the plurality of icons, transmitting the menu to the user computer for display on the user computer display; and
responsive to user scrolling through the menu, transmitting a cursor position to the user computer so that the menu on the user display replicates the menu on the selection device display.

14. The computer program product of claim 12, wherein the instructions further include the step of:
allowing the user to determine the format for the menu from a group selected from a wheel, a page view, or an orb; and
enabling the user to determine an icon shape for the plurality of icons.

15. A computer-implemented method comprised of a series of instructions that cause a computer to perform a process of providing a user with a plurality of menu icons for a plurality of computer applications and a process of allowing a user to select a menu icon corresponding to a particular application for viewing on the user computer display, the computer-implemented method implementing the steps of:
displaying the plurality of menu icons representing the plurality of applications available to the user on the user computer on the selection device display;
enabling the user to scroll through the plurality of menu icons to select the menu icon corresponding to the particular application to view on the user computer display; and
responsive to the user selecting the menu icon, transmitting an identifier for the particular application to the user computer.

16. The computer-implemented method of claim 15, further including the steps of:
determining whether the menu icon of the plurality of menu icons is in a selection window within the selection device display; and
highlighting the menu icon if it is in the selection window,
wherein the user can only select the menu icon when it is highlighted.

17. The computer-implemented method of claim 15, further including the steps of:
determining whether the menu icon of the plurality of menu icons is in a selection window within the selection device display;
enlarging the menu icon if it is in the selection window so that it is larger than the plurality of icons,
wherein the user can only select the menu icon when it is enlarged.

18. The computer-implemented method of claim 15, further including the steps of:
determining whether the menu icon of the plurality of menu icons is in a selection window within the selection device display;
highlighting the menu icon if it is in the selection window; and
enlarging the menu icon if it is in the selection window,
wherein the user can only select the menu icon when it is highlighted and enlarged.

19. The computer-implemented method of claim 15, further including the steps of:
uploading the plurality of icons corresponding to the plurality of applications from the user computer;
creating a menu using the plurality of icons corresponding to the plurality of applications from the user computer into a menu;
displaying the menu on the selection device display.

20. The computer-implemented method of claim 19, further including the steps of:
responsive to the creation of the menu using the plurality of icons, transmitting the menu to the user computer for display on the user computer display; and
responsive to user scrolling through the menu, transmitting a cursor position to the user computer so that the menu on the user display replicates the menu on the selection device display.
